(19) United States
(12) Patent Application Publication
(10) Pub. No.: US 2024/0256908 A1
(43) Pub. Date: Aug. 1, 2024

(54) RECOMMENDATION POLICY MANAGER FOR PREDICTIVE NETWORKING

(71) Applicant: Cisco Technology, Inc., San Jose, CA (US)

(72) Inventors: Jean-Philippe Vasseur, Combloux (FR); Grègory Mermoud, Venthône (CH); Pierre-André Savalle, Rueil-Malmaison (FR); Eduard Schornig, Haarlem (NL)

(21) Appl. No.: 18/103,028

(22) Filed: Jan. 30, 2023

(51) Int. Cl. G06N 5/022

(52) U.S. Cl. CPC G06N 5/022

(57) ABSTRACT

In one embodiment, a device obtains a plurality of characteristics of different portions of a network for which a predictive networking engine is available. The device provides the plurality of characteristics of the different portions of a network to a user interface. The device receives, via the user interface, a set of one or more constraints to limit recommendations by the predictive networking engine for a selected portion of the network from among the different portions of the network. The device configures the predictive networking engine to prevent it from generating recommendations for the selected portion of the network according to the set of one or more constraints.

### TECHNICAL FIELD

The present disclosure relates generally to computer networks, and, more particularly, to a recommendation policy manager for predictive networking.

### BACKGROUND

Software-defined wide area networks (SD-WANs) represent the application of software-defined networking (SDN) principles to WAN connections, such as connections to cellular networks, the Internet, and Multiprotocol Label Switching (MPLS) networks. The power of SD-WAN is the ability to provide consistent service level agreement (SLA) for important application traffic transparently across various underlying tunnels of varying transport quality and allow for seamless tunnel selection based on tunnel performance characteristics that can match application SLAs and satisfy the quality of service (QOS) requirements of the traffic (e.g., in terms of delay, jitter, packet loss, etc.).

With the recent evolution of machine learning, predictive networking in an SDN/SD-WAN, as well as other forms networks, now becomes possible. Generally, predictive networking represents an evolution over traditional networking approaches, which were reactive in nature and relied on the detection of an actual failure in the network before initiating corrective measures (e.g., rerouting traffic onto another path). In contrast, predictive networking seeks to predict failures before they actually occur, so that corrective measures can be taken in advance.

While predictive networking is quite promising, there are many instances in which a network administrator may wish to limit the recommendations by the predictive networking system to only a subset of the entire network, for a variety of reasons. For instance, there may be regulatory or criticality concerns for a portion of the network, a desire to evaluate how the predictive networking system performs for a portion of the network, or the like.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for a recommendation policy manager for predictive networking; and

FIG. 6 illustrates an example simplified procedure for managing recommendations by a predictive networking system.

### DESCRIPTION OF EXAMPLE EMBODIMENTS

### Overview

According to one or more embodiments of the disclosure, a device obtains a plurality of characteristics of different portions of a network for which a predictive networking engine is available. The device provides the plurality of characteristics of the different portions of a network to a user interface. The device receives, via the user interface, a set of one or more constraints to limit recommendations by the predictive networking engine for a selected portion of the network from among the different portions of the network. The device configures the predictive networking engine to prevent it from generating recommendations for the selected portion of the network according to the set of one or more constraints.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

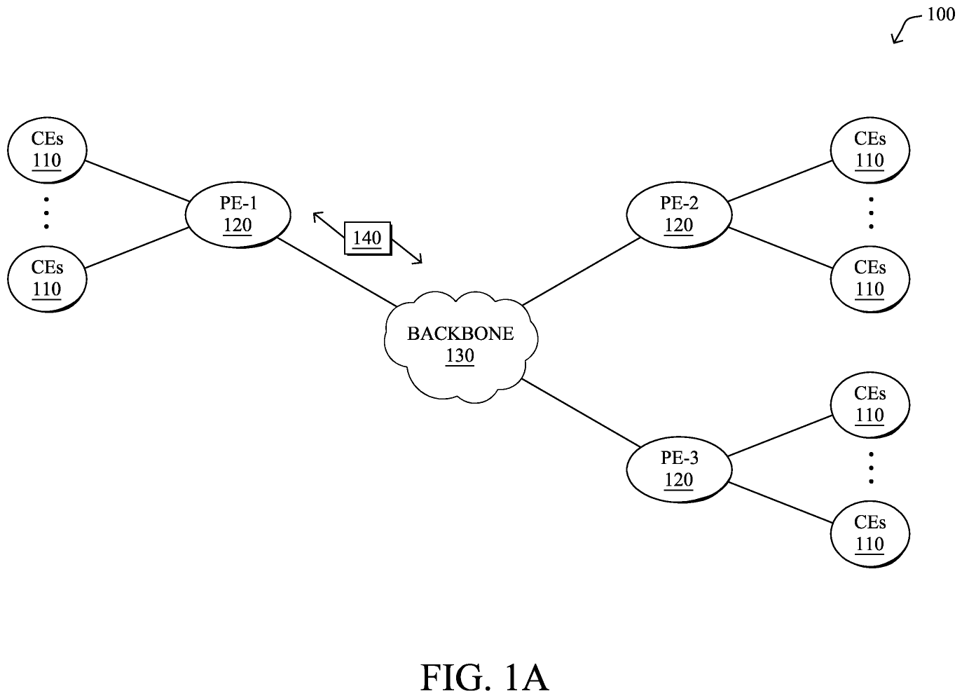

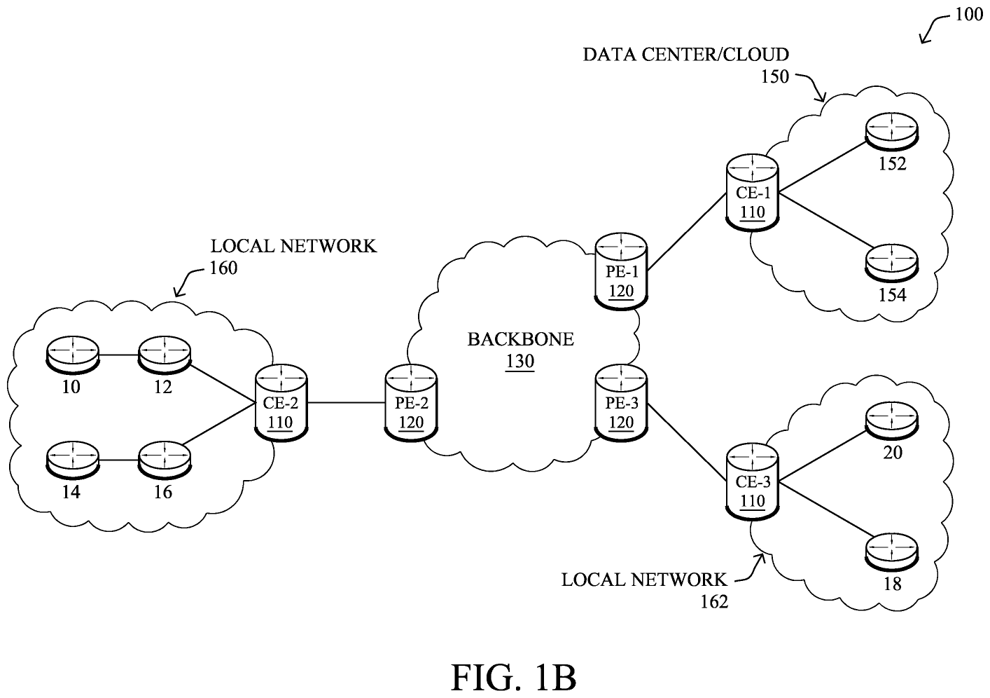

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

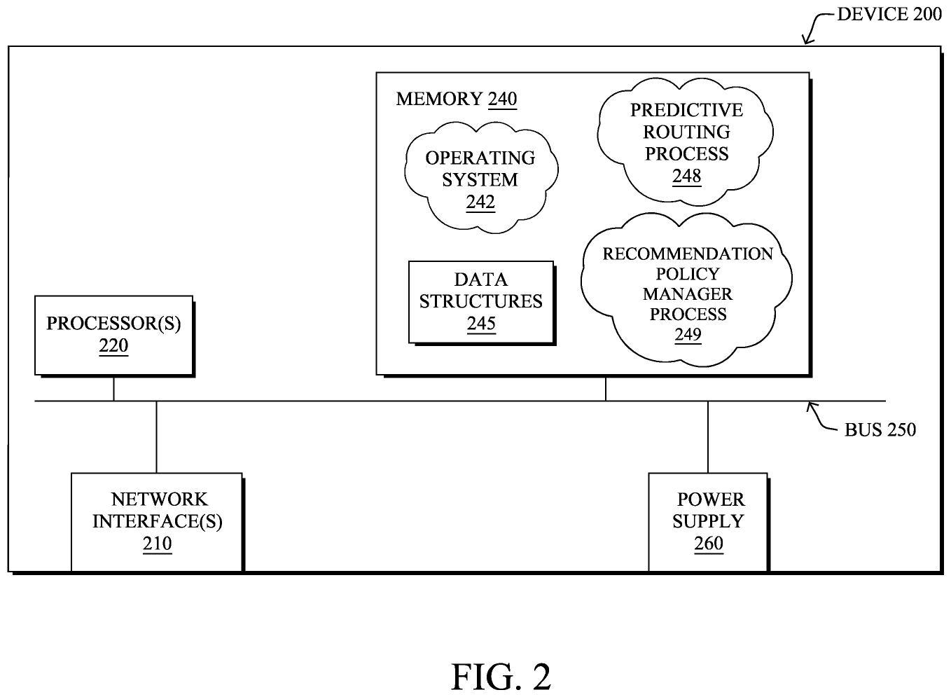

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a predictive networking process 248 and/or a recommendation policy manager process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, predictive networking process 248 and/or a recommendation policy manager process 249 may include computer executable instructions that, when executed by processor(s) 220, cause device 200 to perform the techniques described herein. To do so, in some embodiments, predictive networking process 248 and/or a recommendation policy manager process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, predictive networking process 248 and/or a recommendation policy manager process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that predictive networking process 248 and/or a recommendation policy manager process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

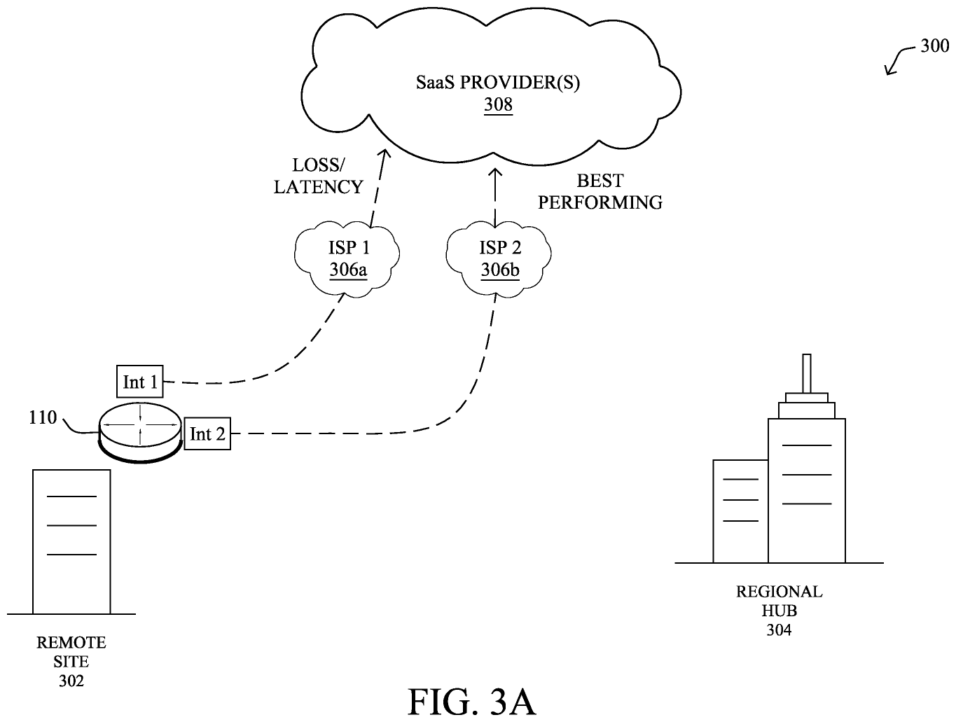

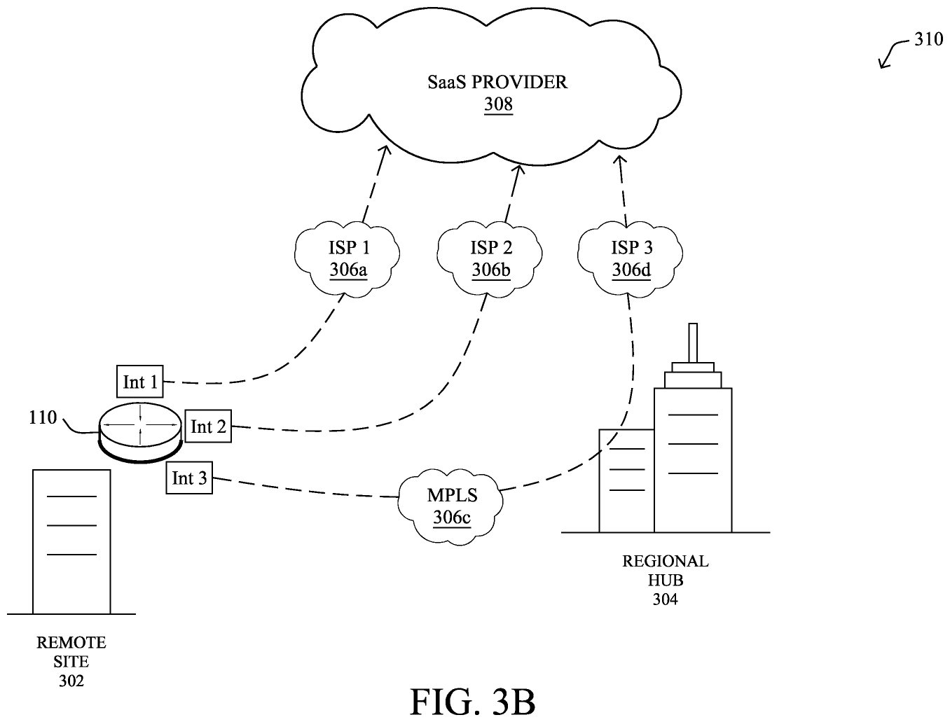

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

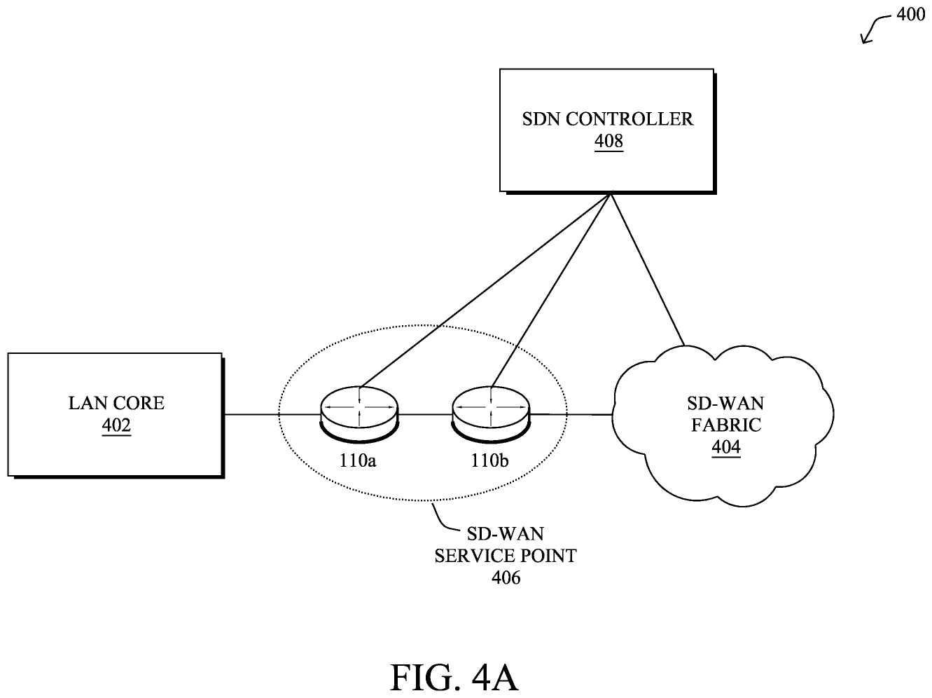

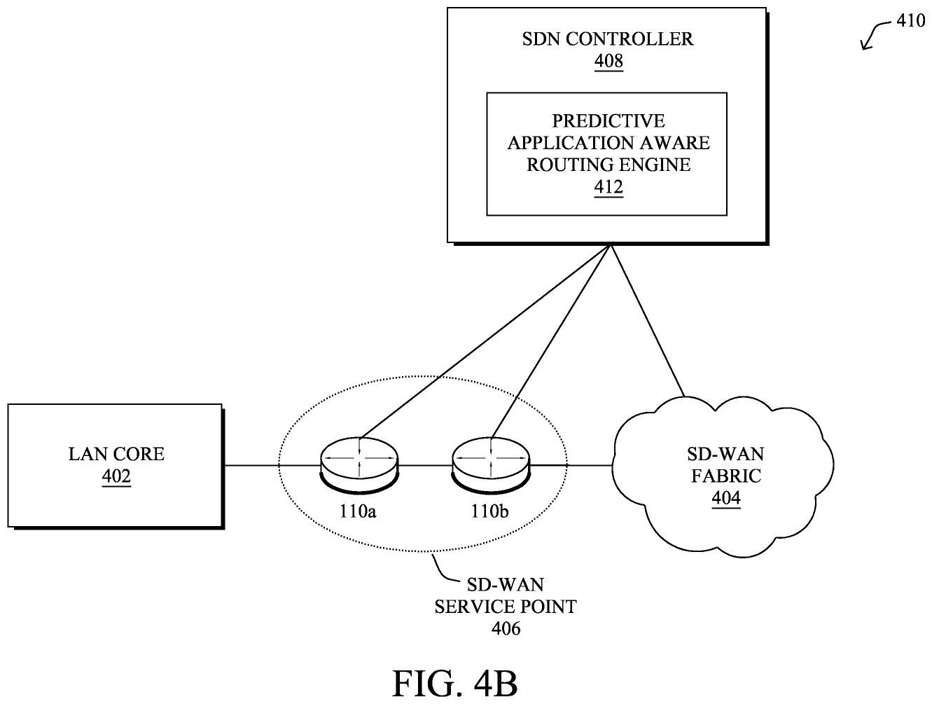

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path.’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of predictive networking process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

In more advanced embodiments, predictive application aware routing engine 412 may predict the QoE of a given application through any or all of the following:
Obtaining user feedback directly from the application. For instance, users of the application may provide ratings, satisfaction surveys, or the like, which predictive application aware routing engine 412 could access via an application programming interface (API) of the application
Applying traffic analytics, such as by analyzing Netflow records that include extra metrics like Application Response Time (ART).
Sending synthetic path probes to measure networking metrics to each SaaS application from each location. These probes are ‘synthetic’ in that they seek to mimic the actual characteristics of the traffic of the application under scrutiny.

As noted above, while predictive networking is quite promising, there are many instances in which a network administrator may wish to limit the recommendations by the predictive networking system to only a subset of the entire network, for a variety of reasons. For instance, there may be regulatory or criticality concerns for a portion of the network, a desire to evaluate how the predictive networking system performs for a portion of the network, or the like.

### ——Recommendation Policy Manager for Predictive Networking——

The techniques herein introduce a policy manager for use in conjunction with a predictive networking system. In some aspects, the policy manager may obtain characteristics of different portions of the network, such as via an API with a network controller (e.g., SD-WAN controller, etc.) or other system that oversees operation of the network. Likewise, another API may collect information from an NMS or other system such as the number of active users per portion, resource utilization, etc. In further aspects, the policy manager may interact with a user interface so as to define a set of constraints to be applied to recommendations by the predictive networking system for any given portion of the network. For instance, these constraints may allow the user to “administratively” include or exclude recommendations according to policy rules based on factors such as the number of users in that portion of the network, QoE experienced at that portion of the network, regulations, the type/role of that portion of the network, etc.

Illustratively, the techniques described herein may be performed by hardware, software, and/or firmware, such as in accordance with recommendation policy manager process 249, which may include computer executable instructions executed by the processor 220 (or independent processor of interfaces 210) to perform functions relating to the techniques described herein, in conjunction with predictive networking process 248.

Specifically, according to various embodiments, a device obtains a plurality of characteristics of different portions of a network for which a predictive networking engine is available. The device provides the plurality of characteristics of the different portions of a network to a user interface. The device receives, via the user interface, a set of one or more constraints to limit recommendations by the predictive networking engine for a selected portion of the network from among the different portions of the network. The device configures the predictive networking engine to prevent it from generating recommendations for the selected portion of the network according to the set of one or more constraints.

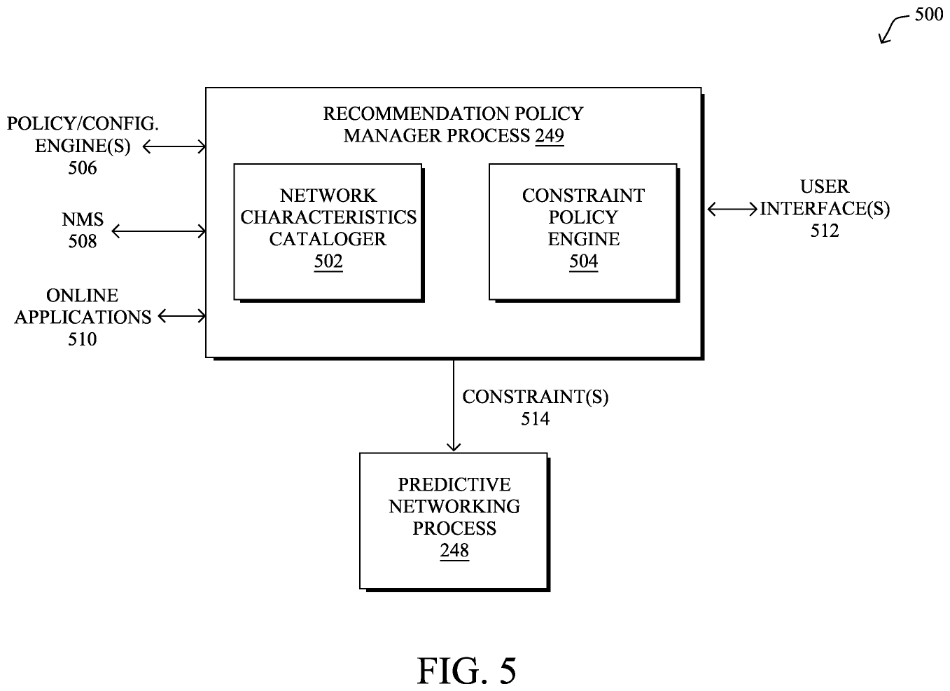

Operationally, FIG. 5 illustrates an example architecture for a recommendation policy manager for predictive networking, according to various embodiments. At the core of architecture 500 is recommendation policy manager process 249, which may be executed by a controller for a network or another device in communication therewith. For instance, recommendation policy manager process 249 may be executed by a controller for a network (e.g., SDN controller 408 in FIGS. 4A-4B), a particular networking device in the network (e.g., a router, etc.), another device or service in communication therewith, or the like, to provide a supervisory service to the network.

More specifically, recommendation policy manager process 249 may operate in conjunction with a predictive application aware routing engine (e.g., that through execution of predictive networking process 248), such as predictive application aware routing engine 412, or directly implemented as a component thereof, in some embodiments.

As shown, recommendation policy manager process 249 may include any or all of the following components: a network characteristics cataloger 502 and/or a constraint policy engine 504. As would be appreciated, the functionalities of these components may be combined or omitted, as desired. In addition, these components may be implemented on a singular device or in a distributed manner, in which case the combination of executing devices can be viewed as their own singular device for purposes of executing recommendation policy manager process 249.

As described previously, predictive networking process 248 may generate what are referred to herein as recommendations that suggest actions (e.g., a configuration change) to avoid an undesirable event that was predicted, such as a network failure, degradation of application experience/QoE, etc. In this context, “predictions” and “recommendations” may be viewed interchangeably to denote outputs of predictive networking process 248. Note also that recommendations and predictions from predictive networking process 248 may have various forecasting horizons, as well: long term (e.g., prediction of issues along a given path several weeks/months ahead), short term (e.g., prediction of issues that may take place in the next day, hours, etc.) or even in (near-) real-time (e.g., prediction of issues a few seconds ahead).

In some embodiments, predictive networking process 248 may also compute a confidence metric associated with any of its recommendations/predictions. For instance, predictive networking process 248 may use a regression model to compute the probability of SLA violation or QoE metric along one or more network paths. The level of confidence of the system for any given recommendation may be governed by the output of the model.

As would be appreciated, the impact/risk for any given recommendation by predictive networking process 248 relates to the potential consequences that any given recommendation can have on the network. For instance, a recommendation by predictive networking process 248 that triggers a change to the forwarding plane on a router may have different consequence than optimizing the response time of control information. As another example, applying a routing change on a site with a few dozen users using Office 365 is not comparable with applying the same change to a large production site with thousands of machines running critical applications. Thus, the impact/risk is a critical factor to a network operator when determining whether or not to apply recommendations by predictive networking process 248 automatically and/or manually.

According to various embodiments, network characteristics cataloger 502 may be configured to obtain a plurality of characteristics of different portions of the network. In some cases, network characteristics cataloger 502 may do so on a pull basis, whereby network characteristics cataloger 502 first requests the relevant characteristic information. In further cases, network characteristics cataloger 502 may do so on a push basis, whereby characteristic information is provided to network characteristics cataloger 502 without it first requesting such information (e.g., reported periodically, in response to a change in the information, etc.).

In some embodiments, network characteristics cataloger 502 may obtain characteristic information about the different portions of the network via application programming interfaces (APIs) with any number of network policy and/or configuration engines 506 associated with the network. For instance, vManage represents one such possible engine from which the network characteristic information may be obtained. An SDN controller represents another such source. In various embodiments, different network characteristics (dimensions) may be obtained from the configuration, policy, and/or inventory data stored by engines 506 such as any or all of the following for a given portion of the network:
The geolocations of that portion of the network
WAN circuits in use: MPLS, Internet, LTE, etc.
WAN circuit capacity (when defined)
The role of the portion of the network: this could specify, for instance, functional site roles such as spoke and hub, datacenter, cloud, etc., which could be determined by analyzing the fabric configuration. In addition, custom tagging or grouping may be in place to assign different roles such as factories, stores, back-offices, etc.
Hardware configuration: e.g., physical device models, cloud instances or on prem virtualized appliances.
Redundancy strategy: e.g., number of circuits used and whether the site is configured as single or dual CPE.
Internet Breakout type: e.g., centralized (via DC or HUB), direct Internet access (DIA) using local connections, secure internet gateway (SIG) via cloud security provider (CSP) like umbrella or zScaler, etc.

Using the data above collected by network characteristics cataloger 502 to provide information to user interface(s) 512, a network administrator could visualize the scope of individual or groups of recommendations to their specific network domain. As described in further detail below, this information may also be made available by network characteristics cataloger 502 to components such as constraint policy engine 504, to create constraint(s) 514 for predictive networking process 248 that restrict recommendations by predictive networking process 248 for selected portions of the network.

In some embodiments, network characteristics cataloger 502 may also obtain further characteristic information from a network management system (NMS) 508, such as via one or more APIs. This additional information may take the form of additional statistics (e.g., average/min/max/percentile) related to the use of the network, such as the estimated number of users per portion of the network (e.g., sites, etc.), link utilizations (per link type), number of incidents logged per-site (e.g., using a customer relations management system such as a Salesforce), or other characteristic information. These types of information could also be provided by network characteristics cataloger 502 via user interface(s) 512 and be pertinent to a network operator to determine the level of sensitivity of specific sites or other portions of the network for which predictive recommendations are being made. For instance, a network operator may decide to restrict predictive networking process 248 from implementing automatic recommendations for a site with a high number of users, high link utilizations, and that experienced a high number of critical cases/support incidents reported by users.

Another potential source of characteristic information obtained by network characteristics cataloger 502 may be the online applications 510 accessed by users of the network. For instance, such characteristic information may include user satisfaction survey data, mean opinion score (MOS) information, user information, or the like. Any or all of this information could also be provided by 502 for review via user interface(s) 512.

According to various embodiments, constraint policy engine 504 may be configured to allow network administrators to define constraints for predictive networking process 248 via user interface(s) 512 that limit recommendations by predictive networking process 248. For instance, such constraints may specify any or all of the following constraints, among others:
Geography: continent, country, region, or city
Site Type: hub, branch, DC, cloud, factory
Recommended action
WAN circuit type or ISP
Site ID List: a list of site IDs that should be excluded or included
Application or application group
Number of Users: number of users for a particular application or site
Performance Indicators: e.g., networking KPIs (delay, loss, jitter) coming from controllers (such as vAnalytics or ThousandEyes), and application-level systems (such as the Webex monitoring engine). Such an indication may be used by the user to decide whether a policy should be configured for a given site (e.g., sites at risk because already
Forecasted Improvement:
   Quality Improvement (as %)
   Number of users impacted or helped
Max number of times unsuccessful recommendations: as recommendations are applied, this number counts the number of those that have been unsuccessful and stop applying recommendations where the threshold is crossed.
Network operator preferences: companies may have very different strategies with regards to predictive networks and automation. Some companies are highly risk adverse (e.g., number of changes should be minimized, changes cannot be applied within specific periods—e.g., holiday season for retailers, 8:00 AM through 5:00 PM for trading, etc.). For instance, constraint policy engine 504 may be configured to indicate different user objectives as possible constraints via user interface(s) 512:
   Minimize impact/risk (lower risk of applying a given recommendation)
   Minimize changes in the network (try to reduce the number of recommendations applied with Automation to avoid fragmenting the configuration policies)
   Etc.

Said differently, recommendation policy manager process 249 may use network characteristics cataloger 502 to obtain characteristics of different portions of the network and present them to a network administrator via user interface(s) 512. Doing so allows the administrator greater insight into the different portions of the network (e.g., sites, data centers, factories, clouds, etc.) and make an assessment as to the risks and rewards associated with using predictive networking process 248 to make recommendations for them. In turn, recommendation policy manager process 249 may also use constraint policy engine 504 to allow the administrator to define, via user interface(s) 512, any number of constraint(s) 514 that limit the recommendations by predictive networking process 248, accordingly.

In various embodiments, constraint policy engine 504 may then configure predictive networking process 248 with constraint(s) 514, so as to prevent it from generating recommendations for any of their corresponding portions of the network, accordingly. This can be achieved by predictive networking process 248 in a number of ways such as by filtering out prediction for portions of the network having characteristics that match constraint(s) 514, preventing its prediction model from even making predictions for portions of the network having characteristics that match constraint(s) 514, preventing predictive networking process 248 from automatically implementing recommendations for portions of the network having characteristics that match constraint(s) 514, or the like.

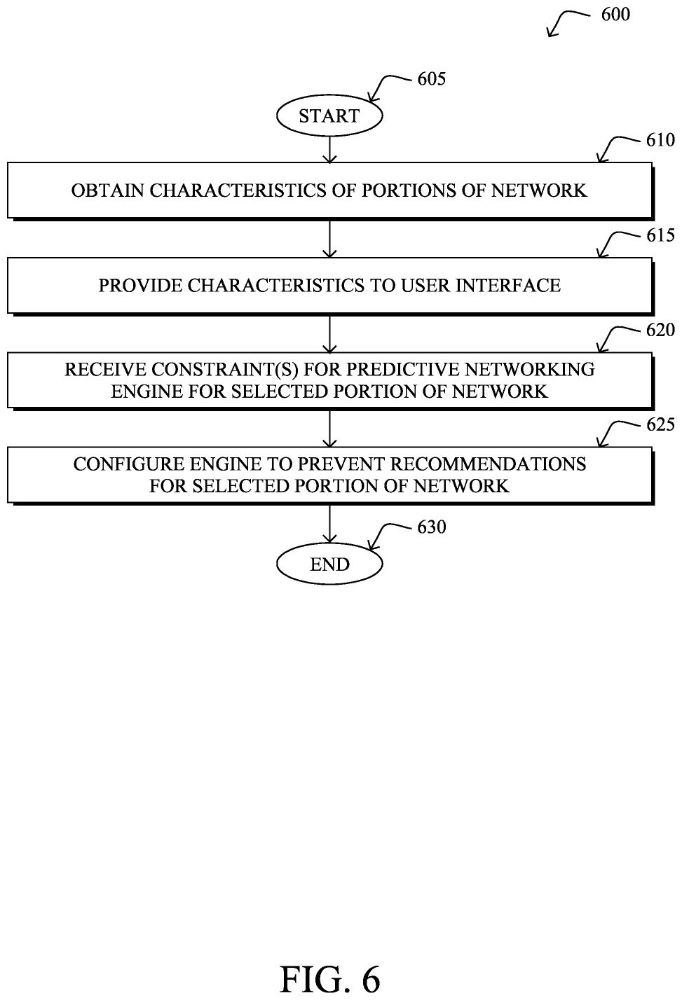

FIG. 6 illustrates an example simplified procedure 600 (e.g., a method) procedure for managing recommendations by a predictive networking system, in accordance with one or more embodiments described herein. For example, a non-generic, specifically configured device (e.g., device 200), such as controller for a network (e.g., an SDN controller or other device in communication therewith), may perform procedure 600 by executing stored instructions (e.g., recommendation policy manager process 249). The procedure 600 may start at step 605, and continues to step 610, where, as described in greater detail above, the device may obtain a plurality of characteristics of different portions of a network for which a predictive networking engine is available. In some embodiments, the device obtains the plurality of characteristics of the different portions of the network from a network controller for the network.

At step 615, as detailed above, the device may provide the plurality of characteristics of the different portions of a network to a user interface. In some embodiments, the plurality of characteristics is indicative of usage of the different portions of the network. In further embodiments, the plurality of characteristics comprises at least one of: a number of users for a particular portion of the network or link utilization in the particular portion of the network. In other embodiments, the plurality of characteristics for the selected portion of the network comprises a metric indicative of a number of critical incidents reported by users in the selected portion of the network. In additional embodiments, the plurality of characteristics of the different portions of the network are indicative of at least one of: wide area network (WAN) circuit information, redundancy strategy information, or an Internet breakout type. In another embodiment, the plurality of characteristics of the different portions of the network are indicative of whether a particular portion of the network is a hub, a branch, a data center, a cloud, or a factory. In yet another embodiment, the plurality of characteristics of the different portions of the network are indicative of different applications whose traffic is conveyed via the different portions of the network.

At step 620, the device may receive, via the user interface, a set of one or more constraints to limit recommendations by the predictive networking engine for a selected portion of the network from among the different portions of the network, as described in greater detail above. In some embodiments, the recommendations by the predictive networking engine comprise a recommendation to reroute traffic for a particular application from one path in the network to another.

At step 625, as detailed above, the device may configure the predictive networking engine to prevent it from generating recommendations for the selected portion of the network according to the set of one or more constraints. In some embodiments, the predictive networking engine comprises a machine learning model configured to predict issues in the network. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for a recommendation policy manager for predictive networking, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, a plurality of characteristics of different portions of a network for which a predictive networking engine is available;
providing, by the device, the plurality of characteristics of the different portions of a network to a user interface;
receiving, at the device and via the user interface, a set of one or more constraints to limit recommendations by the predictive networking engine for a selected portion of the network from among the different portions of the network; and
configuring, by the device, the predictive networking engine to prevent it from generating recommendations for the selected portion of the network according to the set of one or more constraints.

2. The method as in claim 1, wherein the plurality of characteristics is indicative of usage of the different portions of the network.

3. The method as in claim 1, wherein the plurality of characteristics comprises at least one of: a number of users for a particular portion of the network or link utilization in the particular portion of the network.

4. The method as in claim 1, wherein the plurality of characteristics for the selected portion of the network comprises a metric indicative of a number of critical incidents reported by users in the selected portion of the network.

5. The method as in claim 1, wherein the device obtains the plurality of characteristics of the different portions of the network from a network controller for the network.

6. The method as in claim 1, wherein the plurality of characteristics of the different portions of the network are indicative of at least one of: wide area network (WAN) circuit information, redundancy strategy information, or an Internet breakout type.

7. The method as in claim 1, wherein the plurality of characteristics of the different portions of the network are indicative of whether a particular portion of the network is a hub, a branch, a data center, a cloud, or a factory.

8. The method as in claim 1, wherein the recommendations by the predictive networking engine comprise a recommendation to reroute traffic for a particular application from one path in the network to another.

9. The method as in claim 1, wherein the plurality of characteristics of the different portions of the network are indicative of different applications whose traffic is conveyed via the different portions of the network.

10. The method as in claim 1, wherein the predictive networking engine comprises a machine learning model configured to predict issues in the network.

11. An apparatus, comprising:
one or more network interfaces;
a processor coupled to the one or more network interfaces and configured to execute one or more processes; and
a memory configured to store a process that is executable by the processor, the process when executed configured to:
obtain a plurality of characteristics of different portions of a network for which a predictive networking engine is available;
provide the plurality of characteristics of the different portions of a network to a user interface;
receive, via the user interface, a set of one or more constraints to limit recommendations by the predictive networking engine for a selected portion of the network from among the different portions of the network; and
configure the predictive networking engine to prevent it from generating recommendations for the selected portion of the network according to the set of one or more constraints.

12. The apparatus as in claim 11, wherein the plurality of characteristics is indicative of usage of the different portions of the network.

13. The apparatus as in claim 11, wherein the plurality of characteristics comprises at least one of: a number of users for a particular portion of the network or link utilization in the particular portion of the network.

14. The apparatus as in claim 11, wherein the plurality of characteristics for the selected portion of the network comprises a metric indicative of a number of critical incidents reported by users in the selected portion of the network.

15. The apparatus as in claim 11, wherein the apparatus obtains the plurality of characteristics of the different portions of the network from a network controller for the network.

16. The apparatus as in claim 11, wherein the plurality of characteristics of the different portions of the network are indicative of at least one of: wide area network (WAN) circuit information, redundancy strategy information, or an Internet breakout type.

17. The apparatus as in claim 11, wherein the plurality of characteristics of the different portions of the network are indicative of whether a particular portion of the network is a hub, a branch, a data center, a cloud, or a factory.

18. The apparatus as in claim 11, wherein the recommendations by the predictive networking engine comprise a recommendation to reroute traffic for a particular application from one path in the network to another.

19. The apparatus as in claim 11, wherein the plurality of characteristics of the different portions of the network are indicative of different applications whose traffic is conveyed via the different portions of the network.

20. A tangible, non-transitory, computer-readable medium storing program instructions that cause a device to execute a process comprising:
obtaining, by the device, a plurality of characteristics of different portions of a network for which a predictive networking engine is available;
providing, by the device, the plurality of characteristics of the different portions of a network to a user interface;
receiving, at the device and via the user interface, a set of one or more constraints to limit recommendations by the predictive networking engine for a selected portion of the network from among the different portions of the network; and
configuring, by the device, the predictive networking engine to prevent it from generating recommendations for the selected portion of the network according to the set of one or more constraints.
